(19) United States
(12) Patent Application Publication
(10) Pub. No.: US 2007/0075616 A1
(43) Pub. Date: Apr. 5, 2007

(54) Electric lamp

(75) Inventor: Hendrik Adrianus Van Sprang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,058

(22) PCT Filed: Nov. 10, 2004
(86) PCT No.: PCT/IB04/52369

§ 371 Date: May 22, 2006

(30) Foreign Application Priority Data
Nov. 25, 2003 (EP) 03104349.0

(51) Int. Cl. H01K 1/30

(52) U.S. Cl. 313/110

(57) ABSTRACT

The electric lamp comprises a lamp vessel (1) which is transparent to visible light and which accommodates a light source (2). The lamp vessel (1) is covered with a combination of a light-absorbing medium (6) and an optical interference film (5) comprising layers of alternately a first layer of a material with a comparatively high refractive index and a second layer of silicon dioxide. According to the invention the maximum reflection Rₘₐₓ of the interference film (5; 15) lies in the range from 0.50≦Rₘₐₓ≦0.90 and in that the variation in the reflection R of the interference film (5; 15) in the wavelength range from 400≦λ≦690 nm ranges from 0.0 to Rₘₐₓ in order to obtain an overall color neutral appearance. In operation, the electric lamp according to the invention emits colored light in the transmission mode and has a substantially color-neutral appearance in the off state.

The invention relates to an electric lamp comprising a light-transmitting lamp vessel in which a light source is arranged,
said electric lamp comprising a light-absorbing medium exhibiting a spectral transition in the visible range,
the spectral transmission T of light transmitted by the light-absorbing medium changes from T≦0.15 to T≧0.75 in a wavelength range having a width λ≦100 nm,

at least a part of the lamp vessel being provided with an interference film.

Such lamps are used in automotive applications, for example as a (halogen) headlamp that, in operation, emits yellow light, as an amber-colored light source in indicators (also referred to as vehicle signal lamps) or as a red-colored light source in brake lights. Such electric lamps are also used for general illumination purposes. Said electric lamps are further used in traffic and direction signs, contour illumination, traffic lights, projection illumination and fiber optics illumination. Alternative embodiments of such lamps comprise lamps wherein the color temperature is increased by means of a suitable combination of a light-absorbing coating and an interference film.

An electric lamp of the type mentioned in the opening paragraph is known from WO 01/97253. In said known electric lamp the light-absorbing medium exhibits a comparatively steep spectral transition in the visible range. The application of a light-absorbing medium having such a comparatively steep spectral characteristic in an electric lamp whose lamp vessel is provided with an interference film results in an electric lamp having an improved color-neutral appearance. The electric lamp is provided with an interference film having an at least substantially flat reflection spectrum over at least substantially the entire visible region. To achieve this, the electric lamp according to WO 01/97253 has a variation in the reflection R of the interference film in the wavelength range from 400≦λ≦690 nm that is less than 10%. The interference film according to WO 01/97253 comprises at least 5 and at most approximately 17 layers. In operation, the electric lamp emits colored light in the transmission mode and has a substantially color-neutral appearance in the off state. The appearance of the electric lamp can e.g. be silvery. For this reason said lamps are also referred to as ‘silver vision’ lamps.

However, a disadvantage of the lamp according to WO 01/97253 is that the silvervision mirror is reflecting both shorter and longer wavelengths, which contribute to the amber emission. This reflections leads to an internal loss that can mount to about 15%. Moreover, the aim according to WO 01/97253 to obtain a substantially flat reflection spectrum in the electric lamp in the wavelength range from 400≦λ≦690 nm results in color variation. Oscillations are observed which are related to the manufacturing process. These oscillations lead to variation in the external appearance of the lamps from greenish to goldish or purplish reflection.

It is an object of the invention to provide an electric lamp of the type described in the opening paragraph, wherein the above disadvantages are obviated.

This object is achieved, in accordance with the invention, in that the maximum reflection Rₘₐₓ of the interference film lies in the range from 0.50≦Rₘₐₓ≦0.90, and in that the variation in the reflection R of the interference film in the wavelength range from 400≦λ≦690 nm ranges from 0.0 to Rₘₐₓ.

The invention is based on the idea that a color neutral appearance is not restricted to a mirror with a flat reflection characteristic but that the same effect can be obtained with a mirror having a gradual variation in reflectivity, being higher in the green and slightly lower in the adjacent higher and lower wavelength ranges. The resulting interference film is much simpler to manufacture and is also highly reflective and has a color neutral appearance.

Preferably, the variation in the reflection R of the interference film in the wavelength range 400≦λ≦690 nm ranges from 0.2 to the maximum value for the filter Rₘₐₓ.

It appears that variation a color neutral appearance can be obtained, while, at the same time, internal loss of light, due to reflections, is decreased.

The interference film according to the invention can have a metallic or silvery appearance. As a result thereof, the electric lamp in accordance with the invention can very suitably be used as an indicator lamp for automotive applications. Statutory regulations define a range, in the 1931 C.I.E. color triangle known to those skilled in the art for the color point of the light emitted by such indicator lamps. A suitable combination of a light-absorbing medium and an interference film applied to an outside surface of the lamp vessel enables the appearance of the electric lamp to be changed. This particularly enables a distinction to be made between the appearance of the electric lamp in the off state and the color of the light emitted by the electric lamp during operation. The aim is, in particular, to provide an electric lamp that, in operation, emits a certain color, for example a so-called amber-colored or red-colored electric lamp, while, in the off state, the electric lamp has an at least substantially color-neutral appearance.

In vehicles it is desirable, for esthetical reasons, to provide indicator lamps and brake lights with a color-neutral appearance. Only when the electric lamp is activated, it shows the desired color, whereby the color point of the light emitted by the electric lamp meets statutory regulations. Moreover, in vehicles there is a tendency to accommodate amber-colored indicator lamps in the same reflector as the headlamp instead of in a separate reflector. In addition, the aim is to use luminaires in vehicles, which are provided with so-called “clear covers”, i.e. an observer situated outside the vehicle can directly see the indicator lamps or brake lamps in the luminaire. For reasons of safety, it is important that, apart from a color-neutral appearance, such indicator lamps are at least substantially free of coloring in reflection at light that is (accidentally) incident on the electric lamp. If, for example, sunlight or light originating from on-coming traffic is incident on a headlamp of a vehicle comprising an indicator lamp, the appearance of said headlamp, in reflection, should be at least substantially colorless or, in reflection, said lamp should emit at least substantially no color. Otherwise, this might confuse other road users and give rise to unsafe and/or undesirable situations.

In reflection, the spectral characteristic of the electric lamp in accordance with the invention differs from the spectral characteristic in transmission. In transmission, the light emitted by the electric lamp meets statutory regulations with respect to the color point, while, in reflection, the electric lamp is color-neutral, the appearance of the electric lamp being, for example, silvery. The current invention applies, in particular, to indicator lamps and brake lights of vehicles.

A synergetic effect is achieved using an electric lamp comprising a combination of a light-absorbing medium with a steep transition and an interference film giving the electric lamp a color-neutral appearance. In addition, the presence of the interference film may increase the stability of the light-absorbing medium in that the interference film serves as an oxygen barrier for the light-absorbing medium. Moreover, the interference film can counteract loss of color of the light-absorbing medium under the influence of external UV light, for example by a suitable material choice, a suitably chosen band gap (for example TiO₂) or as a result of the fact that the interference film also reflects UV light. Experiments have shown that the adhesion of the combination of light absorbing medium and interference film on the lamp vessel of the electric lamp is satisfactory and not, or hardly, subject to change during the service life. During the service life of the electric lamp in accordance with the invention, no visible delamination of the applied coatings is detected.

An embodiment of an electric lamp in accordance with the invention is characterized in that a wall of the lamp vessel comprises the light-absorbing medium. Light-absorbing media can be readily incorporated in the wall of the lamp vessel, which is made, for example, from glass, such as quartz glass or hard glass, or from a transparent ceramic material. In this embodiment, the interference film is preferably directly applied to a side of the wall of the lamp vessel facing away from the light source. As the light-absorbing medium is provided in the wall of the lamp vessel and the interference film, light, which is reflected by the interference film, passes the light-absorbing medium twice, which leads to a further improvement of the effectiveness of the absorption process. In addition, light that is reflected to and fro between the interference film on both sides of the lamp vessel passes the light-absorbing medium twice at each reflection.

An alternative embodiment of the electric lamp in accordance with the invention is characterized in that the light-absorbing medium comprises a light-absorbing layer that is situated between the lamp vessel and the interference film. As the light-absorbing medium is arranged between the outside surface of the lamp vessel and the interference film, light, which is reflected by the interference film, passes the light-absorbing medium twice, which leads to a further improvement of the effectiveness of the absorption process. In addition, light that is reflected to and fro between the interference film on both sides of the lamp vessel passes the light-absorbing layer twice at each reflection.

A thickness tabs of the light-absorbing layer preferably lies in a range from 5 nm≦tabs≦5000 nm. If the thickness of the light-absorbing layer is smaller than 5 nm, absorption hardly takes place and the intended shift of the color temperature is insufficiently achieved. If the thickness of the layer exceeds 5 μm, too much light is absorbed, which adversely affects the lumen output of the electric lamp. A light-absorbing layer having a thickness of 1.5≦t_{abs}≦2 μm is very suitable. The desired layer thickness is also prompted by the concentration of the pigment in the light-absorbing coating. In case of an absorber which does not contain pigment particles but acts as an absorber directly, the thickness can be much less and of the order of 10-100 nm. Examples known to those skilled in the art are the use of sputtered or evaporated Fe₂O₃ layers or layers of similar materials.

In a preferred embodiment, the light-absorbing coating comprises a network, which can be obtained by converting an organically modified silane by means of a sol-gel process, said organically modified silane being selected from the group formed by compounds of the structural formula R^{I}Si(OR^{II})₃, R^{I} comprising an alkyl group or an aryl group such as CH₃ or C₆H₅, and R^{II} comprising an alkyl group such as CH₃ or C₂H₅.

By making the light-absorbing layer from a network comprising an organically modified silane as the starting material, an optically transparent, non-scattering, light-absorbing coating is obtained which is capable of resisting temperatures up to 400° C. By using an organically modified silane in the manufacture of the network, a part of the R^{I} groups, the alkyl or aryl groups, remains in the network as an end group. As a result, the network does not comprise four network bonds per Si atom, but less than four network bonds per Si atom. In this manner, for example, a network is obtained comprising, on average, approximately three network bonds per Si atom. In spite of the fact that the network is partly composed of said alkyl or aryl groups, a network is obtained whose density is at least substantially equal to that of the customary silica network. Unlike the customary silica network, a network which is partly composed of said alkyl or aryl groups has a greater elasticity and flexibility. As a result, it becomes possible to manufacture comparatively thick light-absorbing coatings.

Particularly suitable starting materials for the manufacture of the network in accordance with the invention are methyltrimethoxysilane (MTMS), wherein R^{I}=R^{II}=CH₃, methyltriethoxysilane (MTES), wherein R^{I}=CH₃ and R^{II}=C₂H₅, phenyltrimethoxysilane (PTMS), wherein R^{I}=C₆H₅ and R^{II}=CH₃, and phenyltriethoxysilane (PTES), wherein R^{I}=C₆H₅ and R^{II}=C₂H₅. Such starting materials are known per se and commercially available.

A preferred embodiment of the electric lamp is characterized in that the light-absorbing medium has an amber-colored or red-colored transmission. Electric lamps that, in operation, emit amber-colored light can particularly suitably be used as an indicator lamp in vehicles. Electric lamps that, in operation, emit red light are particularly suitable as brake lights in vehicles.

The choice of selectively light-absorbing layers is limited by the requirement which, in accordance with the invention, is to be met by the steepness of the change of the spectral transmission of the light-absorbing medium. The choice of selectively light-absorbing layers is further limited by the thermal requirements to be met by such a light-absorbing layer. Said thermal requirements include the durability of the light-absorbing medium during the service life and the resistance to changing temperatures of the lamp vessel.

Preferably, the light-absorbing medium has an amber-colored transmission. A particularly suitable light-absorbing medium is chromophtal yellow, chemical formula C₂₂H₆C₁₈N₄O₂ and C.I. (constitution number) 56280. This organic dye is also referred to as “C.I.—110 yellow pigment”, “C.I. pigment yellow 137” or Bis[4,5,6,7-tetrachloro-3-oxoisoindoline-1-ylidene)-1,4-phenylenediamine. An alternative light-absorbing medium having an amber-colored transmission is yellow anthraquinone, chemical formula C₃₇H₂₁N₅O₄ and C.I. 60645. This organic dye is also referred to as “Filester yellow 2648A” or “Filester yellow RN”, chemical formula 1,1′-[(6-phenyl-1,3,5-triazine-2,4diyl)diimino]bis-.

In an alternative embodiment, the light-absorbing medium has a red-colored transmission and comprises, by way of example, “chromophtal red A2B” with C.I. 65300. Said organic dye is alternatively referred to as “pigment red 177”, dianthraquinonyl red or as [1,1′-Bianthracene]-9,9′,10,10′-tetrone, 4,4′-diamino-(TSCA, DSL).

An embodiment of the electric lamp in accordance with the invention is characterized in that the interference film comprises layers of, alternately, a first layer of a material having a comparatively high refractive index and a second layer of a material having a comparatively low refractive index. The use of two materials simplifies the provision of the interference film.

A preferred embodiment of the electric lamp in accordance with the invention is characterized in that the second layer of the interference film comprises predominantly silicon oxide, and the first layer of the interference film comprises predominantly a material having a refractive index which is high as compared to a refractive index of silicon oxide. Layers of silicon oxide can be provided comparatively readily using various deposition techniques.

Preferably, the first layer of the interference film comprises a material chosen from the group formed by titanium oxide, tantalum oxide, zirconium oxide, niobium oxide, hafnium oxide, silicon nitride and combinations of said materials. Preferably, the material of the first layer of the interference film predominantly comprises titanium oxide or niobium oxide.

Preferably, the interference films are TiO₂/SiO₂ type films or Nb₂O₅/SiO₂ type films and comprise preferably, 3-5 layers, most preferably 3 layers. As a consequence of the small number of layers, the interference film is simple to manufacture and the manufacturing costs of such film are relatively low. Moreover, the filter is less sensitive to oscillations in the reflection spectrum. In order to obtain a preferred high reflection maximum Rₘₐₓ, the high refractive index material preferentially has a high index of about n=2.7 at 500 nm. The deposition of such a layer by use of mid-frequency or AC sputtering of titania is known to those skilled in the art.

The light source of the lamp may be an incandescent body, for example in a halogen-containing gasor it may be an electrode pair in an ionizable gas, for example an inert gas with metal halides, possibly with, for example, mercury as a buffer gas. An innermost gastight envelope may surround the light source. It is alternatively possible, that the outermost envelope surrounds the lamp vessel.

The interference film and the light-absorbing layer may be provided in a customary manner by means of, for example, vapor deposition (PVD: physical vapor deposition) or by a suitable sputtering technique or by means of a dip-coating or spraying process or by means of LP-CVD (low-pressure chemical vapor deposition), PE-CVD (plasma-enhanced CVD) or PI-CVD (plasma impulse chemical vapor deposition). The light-absorbing layer on the outer wall of the lamp vessel is preferably applied by means of spraying. If the light-absorbing medium forms part of the wall of the lamp vessel, then this medium is generally provided in the wall in the course of the manufacture of the lamp vessel.

It has been found that the combination of absorbing medium and interference film of the electric lamp in accordance with the invention substantially preserves its initial properties throughout the service life of the electric lamp.

These and other aspects of the invention will be apparent from and elucidated with reference to the embodiment(s) described hereinafter.

In the drawings:

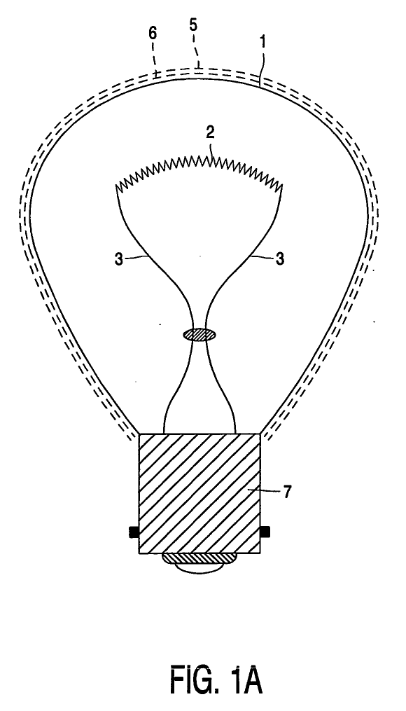

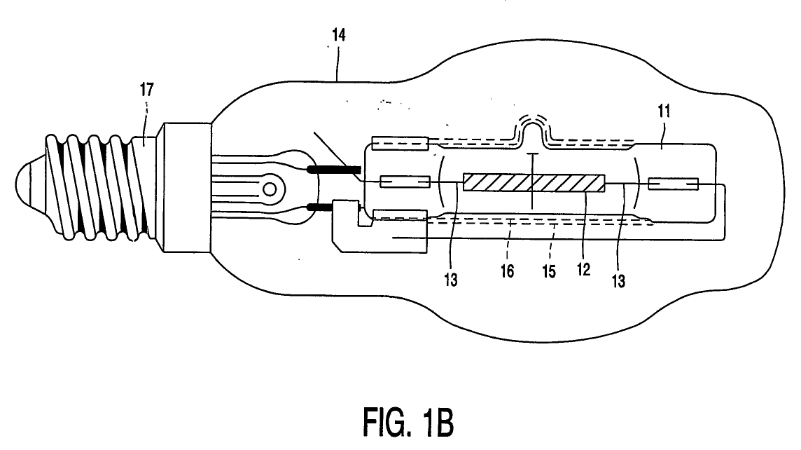

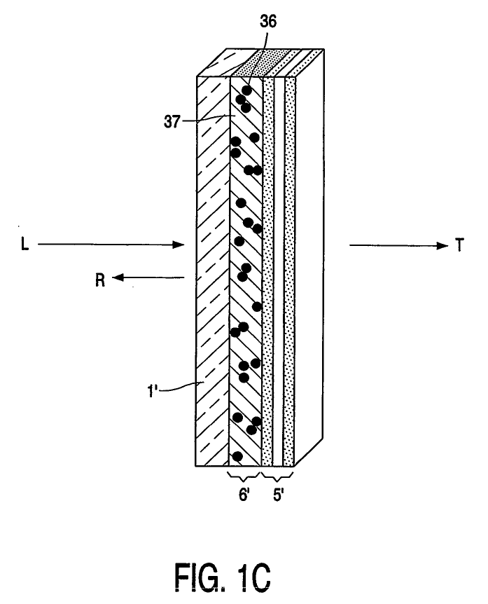

FIG. 1A is a cross-sectional view of an embodiment of the electric lamp in accordance with the invention;

FIG. 1B is a side view of an alternative embodiment of the electric lamp in accordance with the invention;

FIG. 1C is a diagrammatic, perspective view of a combination of a light-absorbing medium and an interference film in accordance with the invention.

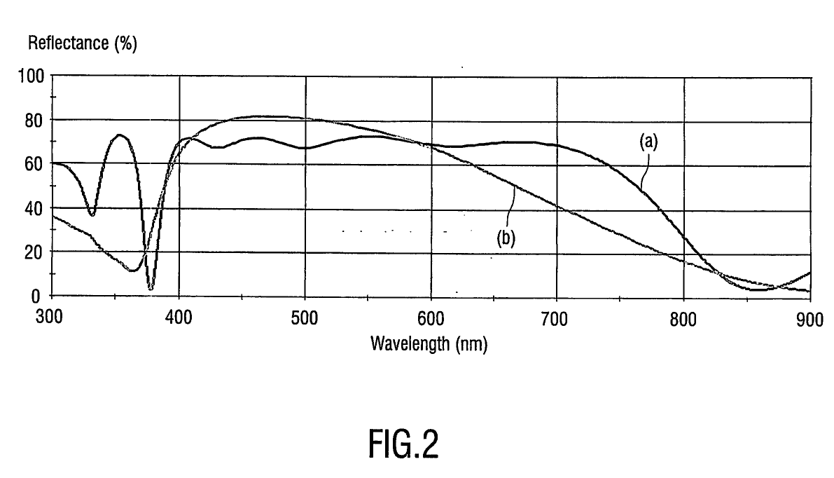

FIG. 2 shows the calculated reflection spectrum as a function of the wavelength of a 3 layer TiO₂/SiO₂ interference film (b) in accordance with the invention compared to a 9 layer Nb₂O₅/SiO₂ interference film (a);

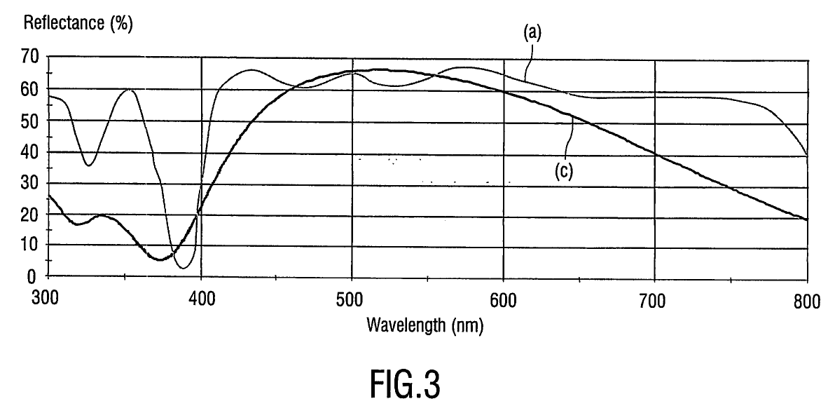

FIG. 3 shows the calculated reflection spectrum as a function of the wavelength of a 3 layer Nb₂O₅/SiO₂ interference film (c) in accordance with the invention compared to a 9 layer Nb₂O₅/SiO₂ interference film (a).

The Figs. are purely schematic and not drawn to scale. Particularly for clarity, some dimensions are exaggerated strongly. In the Figures, like reference numerals refer to like parts whenever possible.

FIG. 1A is a cross-sectional view of an embodiment of the electric lamp in accordance with the invention. Said electric lamp has a light-transmitting lamp vessel 1, for example of glass, which is sealed in a gastight manner and which accommodates an electric element 2, in the Figure a (spiral-shaped) tungsten incandescent body, which is connected to current conductors 3 which issue from the lamp vessel 1 to the exterior. The lamp shown, which is alternatively referred to as PY21W (12 volt, 21 watt) is filled with an inert gas, for example an Ar/N₂ mixture, having a filling pressure of approximately 1 bar.

In the embodiment of the electric lamp shown in FIG. 1A, the light-absorbing medium is provided, in the form of a light-absorbing coating 6, on an outside of the lamp vessel 1 (on a wall of the lamp vessel), and an interference film 5 is provided on said light-absorbing coating (also see FIG. 1B). The light-absorbing coating 6 comprises, in this case, for example a layer of the pigment (in the MTMS matrix) referred to as chromophtal yellow in a layer thickness of, for example, 2 μm. An electric lamp provided with such a light-absorbing medium emits, in operation, amber-colored light, the spectral transmission in the visible region exhibiting a transition from T≦0.1 to T≧0.9 in a wavelength range from approximately 500≦λ≦560 nm (the width of the wavelength range is approximately 60 nm). Such electric lamps are used as an indicator lamp, for example, in indicators of vehicles, and their service life is at least substantially 1200 hours. In an alternative embodiment of the coating, the light-absorbing coating 6 comprises a layer of chromophtal red A2B having a layer thickness of for example 2 μm. An electric lamp provided with such a chromophtal red A2B layer emits, in operation, red-colored light. Such electric lamps are used as brake lights in vehicles, and their service life is at least substantially 1200 hours.

In an alternative embodiment of the electric lamp shown in FIG. 1A, the wall of the lamp vessel comprises the light-absorbing medium.

In FIG. 1A, an interference film 5 is applied to the light-absorbing medium applied to the wall of the lamp vessel 1 (the “substrate”), which interference film comprises layers of alternately a first layer of a material having a comparatively high refractive index (also see FIG. 1C), for example titanium oxide (average refractive index of TiO₂ approximately 2.4-2.8) or niobium oxide (average refractive index of Nb₂O₅ approximately 2.34), and a second layer of, predominantly, silicon oxide (average refractive index approximately 1.46). The TiO₂/SiO₂ or Nb₂O₅/SiO₂ interference films preferably comprise only a small number of layers, preferably 3-5 layers. However, most preferred is an interference filter comprising only 3 layers. As a result of the comparatively small number of layers, the manufacturing costs of such an interference film are comparatively low.

FIG. 1B is a side view of an alternative embodiment of the electric incandescent lamp in accordance with the invention. Said electric lamp comprises a quartz glass lamp vessel 11 accommodating an incandescent body as the light source 12. Current conductors 13 are connected to said light source and issue from the lamp vessel 11 to the exterior. The lamp vessel 11 is filled with a halogen-containing gas, for example hydrogen bromide. At least a part of the lamp vessel 11 is covered with a light-absorbing medium 16 in the form of a light-absorbing coating, which, in this example, is formed by (a MTMS matrix-containing) chromophtal yellow or chromophtal red A2B in a layer thickness of approximately 2 μm.

In the example shown in FIG. 1B, an interference film 15 is applied to the light-absorbing medium 16 and comprises layers of, alternately, a first layer of predominantly titanium oxide and a second layer of a material comprising predominately silicon oxide. The TiO₂/SiO₂ interference film preferably comprises a very small number of layers. Experiments have shown that an interference film comprising three layers of TiO₂/SiO₂ is sufficient to obtain an average reflection of 76%.

The lamp vessel 11 in FIG. 1B is mounted in an outer bulb 14, which is supported by a lamp cap 17 to which the current conductors 13 are electrically connected. The lamp shown is a 60 W mains-voltage lamp having a service life of at least substantially 2500 hours.

FIG. 1C is a very diagrammatic, perspective view of a combination of a light-absorbing medium and an interference film in accordance with the invention. The light-absorbing medium 6′ is provided on a substrate 1′ (for example the glass wall of a lamp vessel) and comprises, in this example, a layer whose thickness is approximately 1-2 μm, which is composed of comparatively small light-absorbing particles 36 (average particle size below 100 nm) which are incorporated in an optically transparent sol-gel matrix 37. An interference film 5′ is applied to this light-absorbing medium 6′, which is built up of alternately a first layer of a material having a high refractive index and a second layer of a material having a comparatively low refractive index. FIG. 1C diagrammatically shows the direction of the incident light, indicated by means of “L”, the direction of the reflected light, indicated by means of “R”, and the direction of the transmitted light, indicated by means of

### EXAMPLE

A coating comprising a light-absorbing medium in a network having an organically modified silane as the starting material is manufactured, for example, as follows:

A pigment (for example chromophtal yellow) having an average particle size below 100 nm is dispersed in a water/ethanol mixture in the presence of “disperbyk 190” as the dispersing agent. An optically clear liquid is obtained by so-called “wet ball milling” using zirconium-oxide grains.

A hydrolysis mixture is prepared by mixing methyltriinethoxysilane (MTMS), tetraethylorthosilicate (TEOS), water, ethanol and glacial acetic acid.

A mixture of the pigment dispersion and the hydrolysis mixture is used to apply a light-absorbing layer (for example 1.5-2 μm) to the lamp vessel by means of spraying. The layer is subsequently cured at 250° C. for 5-10 minutes.

Table I and II show two embodiments of combinations of a light-absorbing medium in the form of a coating including an amber or red pigment and a three-layer TiO₂/SiO₂ interference film having a maximum reflection of 80% or a three-layer Nb₂O₅/SiO₂ interference film having a maximum reflection of 70%.

TABLE I
Embodiment of a first combination of a
light-absorbing medium (pigment) and a TiO₂/SiO₂
interference film having a maximum reflection Rₘₐₓ = 0.8.

| Layer | Material | Thickness (nm) |
|---|---|---|
| | substrate (glass) | — |
| 1 | Pigment | ≈1800 |
| 2 | TiO₂ | 40 |
| 3 | SiO₂ | 91 |
| 4 | TiO₂ | 42 |
| | air | — |

TABLE II
Embodiment of a second combination of a
light-absorbing medium (pigment) and a Nb₂O₅/SiO₂
interference film having a maximum reflection Rₘₐₓ = 0.68.

| Layer | Material | Thickness (nm) |
|---|---|---|
| | substrate (glass) | — |
| 1 | pigment | ≈1800 |
| 2 | Nb₂O₅ | 51 |
| 3 | SiO₂ | 99 |
| 4 | Nb₂O₅ | 54 |
| | air | — |

FIG. 2 shows the calculated reflection spectrum as a function of the wavelength of a 3 layer TiO₂/SiO2₂ interference film in accordance with the invention (b) compared to a 9 layer Nb₂O₅/SiO₂ interference film (a).

The figure shows that the reflectance of the three layer TiO₂/SiO₂, based on two layers of high optical index TiO₂ and one layer of SiO₂ in between, is even more reflective than the 9 layer filter consisting of alternating layers of Nb₂O₅ and SiO₂. The light emission for the 3-layer interference filter according to the present invention will also be higher. Calculations estimate 10% increase for PY lamps.

FIG. 3 shows the calculated reflection spectrum as a function of the wavelength of a 3 layer Nb₂O₅/SiO₂ interference film in accordance with the invention (c) compared to a 9 layer Nb₂O₅/SiO₂ interference film (a).

Although the reflectivity for the 3 layer Nb₂O₅ system is slightly lower than for the higher index TiO₂ material, the expected luminous output is increased with about 20 when compared with the 9 layer Nb₂O₅/SiO₂ filter. Measurements show that the luminous output of lamps made with this filter show an increase of 15% with respect to the luminous output of the lamps made with the 9 layer filter, which are also shown.

It will be clear that, within the scope of the invention, many variations are possible to those skilled in the art.

The scope of protection of the invention is not limited to the examples given herein. The invention is embodied in each novel characteristic and each combination of characteristics. Reference numerals in the claims do not limit the scope of protection thereof. The use of the verb “to comprise” and its conjugations does not exclude the presence of elements other than those mentioned in the claims. The use of the article “a” or “an” in front of an element does not exclude the presence of a plurality of such elements.

1. An electric lamp comprising a light-transmitting lamp vessel (1; 11) in which a light source (2; 12) is arranged,
said electric lamp comprising a light-absorbing medium (6; 16) exhibiting a spectral transition in the visible range,
the spectral transmission T of light transmitted by the light-absorbing medium (6; 16) changes from T≦0.15 to T≧0.75 in a wavelength range having a width λ≦75 nm,
at least a part of the lamp vessel (1; 11) being provided with an interference film (5; 15), characterized in that the maximum reflection Rₘₐₓ of the interference film (5; 15) lies in the range from 0.50≦Rₘₐₓ≦0.90 and in that the variation in the reflection R of the interference film (5; 15) in the wavelength range from 400≦λ≦690 nm ranges from 0.0 to Rₘₐₓ.

2. An electric lamp as claimed in claim 1, characterized in that the variation in the reflection R of the interference film (5; 15) in the wavelength range from 400≦λ≦690 nm ranges from 0.2 to Rₘₐₓ.

3. An electric lamp as claimed in claim 1, characterized in that a wall of the lamp vessel (1) comprises the light-absorbing medium.

4. An electric lamp as claimed in claim 1, characterized in that the light-absorbing medium (6; 16) comprises a light-absorbing coating which is situated between the lamp vessel (11) and the interference film (15).

5. An electric lamp as claimed in claim 1, characterized in that the electric lamp emits colored light, in operation, and has an at least substantially color-neutral appearance in the off state.

6. An electric lamp as claimed in claim 1, characterized in that the light-absorbing medium (6; 16) comprises an amber-colored or red-colored transmission

7. An electric lamp as claimed in claim 1, characterized in that the interference film (5; 15) comprises layers of alternately a first layer of a material having a comparatively high refractive index and a second layer of a material having a comparatively low refractive index.

8. An electric lamp as claimed in claim 7, characterized in that the second layer of the interference film (5; 15) comprises predominantly silicon oxide, and in that the first layer of the interference film (5) predominantly comprises a material whose refractive index is high in comparison with a refractive index of silicon oxide.

9. An electric lamp as claimed in claim 7, characterized in that the first layer of the interference film (5; 15) comprises a material selected from the group formed by titanium oxide, tantalum oxide, zirconium oxide, niobium oxide, hafnium oxide, silicon nitride and combinations of said materials.

10. An electric lamp as claimed in claim 7, characterized in that the first layer of the interference film (5; 15) comprises a material selected from the group formed by titanium oxide and niobium oxide.

11. An electric lamp as claimed in claim 7, characterized in that the interference film comprises 3-5 layers.

12. An electric lamp as claimed in claim 7, characterized in that the interference film comprises 3 layers.
